(19) United States
(12) Patent Application Publication
(10) Pub. No.: US 2013/0158858 A1
(43) Pub. Date: Jun. 20, 2013

(54) NAVIGATION DEVICE AND METHOD FOR MARKING TRAFFIC CONDITIONS ON NAVIGATION MAP

(71) Applicant: HONG-YU YANG, Shenzhen City (CN)

(72) Inventor: HONG-YU YANG, Shenzhen City (CN)

(73) Assignee: HON HAI PRECISION INDUSTRY CO., LTD., Tu-Cheng (TW)

(21) Appl. No.: 13/407,776

(22) Filed: Feb. 29, 2012

(30) Foreign Application Priority Data
Dec. 14, 2011 (CN) 201110416942.4

(51) Int. Cl. G01C 21/26

(52) U.S. Cl. 701/409; 701/532

(57) ABSTRACT

A navigation device includes a data storage for storing a navigation map, and a keyword database. The keyword database stores a number of keywords. The number of keywords are grouped into road keywords and traffic condition keywords. Each road keyword is mapped to one road on the navigation map and each traffic condition keyword corresponds to a particular traffic condition. The navigation device detects road keywords and the traffic condition keywords associated with the detected road keywords in the received audio and marks the traffic condition on the corresponding road on the navigation map according to the detected road keyword and any associated traffic condition.

### BACKGROUND

1. Technical Field

The present disclosure relates to a navigation device, and particularly to a navigation device for marking traffic conditions on a navigate on map and a method thereof.

2. Description of Related Art

Navigation devices are used in vehicles to provide navigation for drivers. However, the navigation device can not provide traffic conditions which are usually broadcasts by the radio devices. Further, due to some drives may not remember or neglect the traffic conditions broadcasted by the radio device, the drivers may become involved with traffic jam and lose time.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a navigation device in accordance with an exemplary embodiment.

FIG. 2 is a flowchart of a method for marking traffic conditions on the navigation map displayed on the navigation device of FIG. 1.

### DETAILED DESCRIPTION

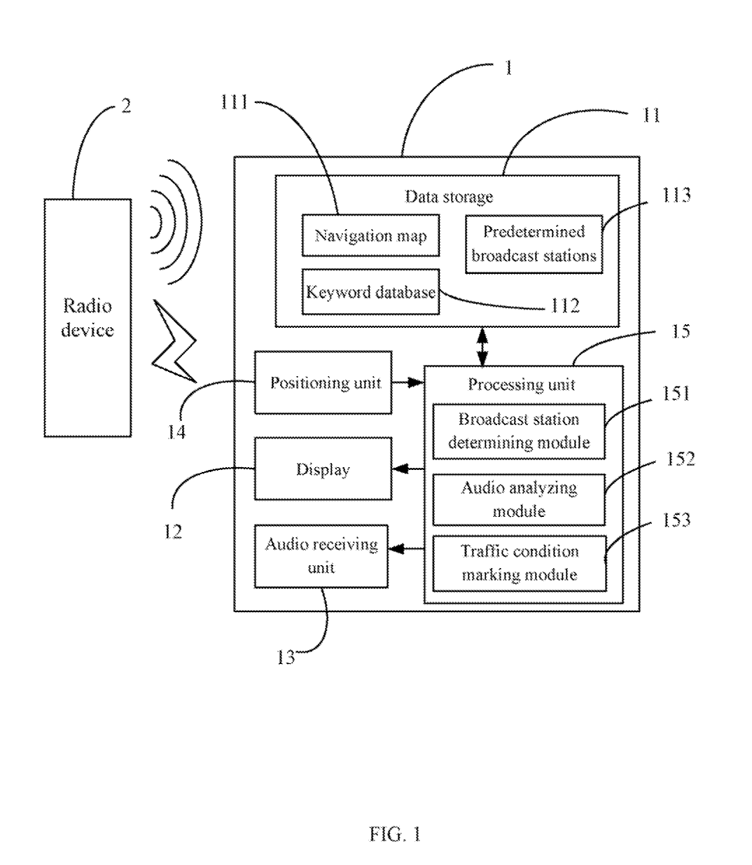

FIG. 1 is a block diagram of a navigation device in accordance with an exemplary embodiment. The navigation device 1 is capable of sending an instruction to the radio device 2 to control the radio device 2 to tune to a desired broadcasting station and relay it to the device 1. In the embodiment, the navigation device 1 is wirelessly connected to the radio device 2.

The navigation device 1 includes a data storage 11, a display 12, an audio receiving unit 13, a positioning unit 14, and a processing unit 15. The data storage 11 stores a navigation map 111, a keyword database 112, and identifier (ID) regarding predetermined broadcast stations 113. The keyword database 112 stores a number of keywords. The keywords are grouped into road keywords and traffic condition keywords. Each road keyword is mapped to one road on the navigation map 111. Each traffic condition keyword corresponds to a traffic condition such as light traffic, heavy traffic, and traffic jam. Each traffic condition keyword is designated a traffic condition mark for representing the traffic condition of the road mapped in the navigation map 111. In the embodiment, the traffic condition marks are curved lines with different colors. For example, the green curved lines are used to represent the light traffic, the blue curved lines are used to represent the heavy traffic, and the red curved lines are used to represent the traffic jam. The predetermined broadcast stations 113 are the broadcast stations which are capable of broadcasting traffic conditions of predetermined areas in real time. The predetermined areas can be cities or districts of one city.

The display unit 12 is for displaying the navigation map 111.

The audio receiving unit 13 is for receiving audio forwarded by the radio device 2.

The positioning unit 14 is for positioning the navigation device 1. In the embodiment, the positioning unit 14 is a global positioning system (GPS) receiver capable of receiving position signals from a GPS satellite.

The processing unit 15 includes a broadcast station determining module 151, an audio analyzing module 152, and a traffic condition marking module 153. The broadcast station determining module 151 determines the current area of the navigation device 1 and any new area entered by the device 1 according to the position positioned by the positioning unit 14, and further determines whether any new area is one of the predetermined areas stored in the data storage 11. If the new area is one of the predetermined areas stored in the data storage 11, the broadcast station determining module 151 obtains the ID of the predetermined broadcast station of the new area, and sends an instruction signal to control the radio device 2 to retune to receive the program of the broadcast station with the obtained ID.

The audio analyzing module 152 is for receiving the audible output forwarded by the radio device 2, and seeking to obtain road keywords and traffic condition keywords associated with the road keywords in the audible output after it has been converted to digital signal. There are two methods for obtaining road keywords and traffic condition keywords associated with the road keywords. One method is: detecting the road keywords and traffic condition keywords stored in the keyword database 112 in the received audio, if one of the road keywords is detected first, further detecting whether there are traffic keywords within a predetermined portion of audio after the detection of a road keyword. The other method is: detecting the road keywords and traffic condition keywords stored in the keyword database 112 in the received audio, and if one of the traffic keyword is detected first, further detecting whether there is one or more road keywords within a predetermined portion of audio after the detection of a traffic keyword.

The traffic condition marking module 153 determining the corresponding road on the navigation map of the detected road keyword and designated traffic condition mark of the detected associated traffic condition keyword of the road keyword and marking the determined road on the navigation map with the determined traffic condition mark.

In the embodiment, the road keywords are grouped according to the predetermined area where the roads are. Each predetermined area corresponds to a group of road keywords. When seeking a road keyword in the received audio, only the corresponding group of road keywords of the predetermined area are listened for as target keywords.

In the embodiment, the traffic condition marking module 153 deletes the traffic condition mark marked on the navigation map 111 after the traffic condition marks have subsisted for a predetermined time.

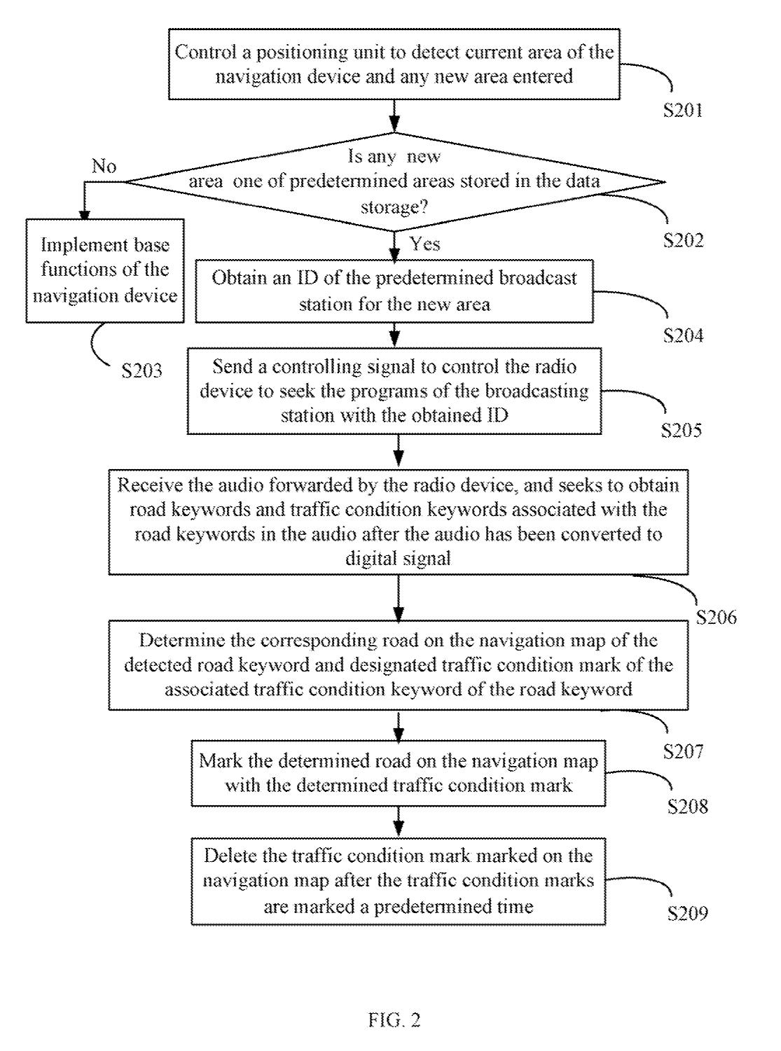

FIG. 2 is a flowchart of a method for marking traffic conditions on the navigation map 111 displayed on the navigation device 1.

In step S201, the broadcast station determining module 151 controls the positioning unit 14 to detect the current area of the navigation device 1 and any new area entered.

In step S202, the broadcast station determining module 151 determines whether any new area is one of the predetermined areas stored in the data storage 11.

In step S203, the navigation device 1 implements base functions of the navigation device 1 if any new area is one of the predetermined areas stored in the data storage 11.

In step S204, the broadcast station determining module 151 obtains the ID of any predetermined broadcast station for the new area.

In step S205, the broadcast station determining module 151 sends a controlling signal to control the radio device 2 to seek the programs of the broadcasting station with the obtained ID.

In step S206, the audio analyzing module 152 receives the audio forwarded by the radio device 2, and seeks to obtain road keywords and traffic condition keywords associated with the road keywords in the audio after the audio has been converted to digital signal.

In step S207, the traffic condition marking module 153 determining the corresponding road on the navigation map of the detected road keyword and designated traffic condition mark of the associated traffic condition keyword of the road keyword.

In step S208, the traffic condition marking module 153 marks the determined road on the navigation map with the determined traffic condition mark.

In step S209, the traffic condition marking module 153 deletes the traffic condition mark marked on the navigation map 111 after the traffic condition marks have subsisted for a predetermined time.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A navigation device comprising:
a data storage for storing a navigation map, a keyword database storing a plurality of keywords, wherein the plurality of keywords are grouped into road keywords and traffic condition keywords, each road keyword being mapped to a road on the navigation map, and each traffic condition keyword corresponding to a traffic condition and being designated a traffic condition mark;
a display for displaying the navigation map;
an audio receiving unit for receiving audio forwarded by a radio device; and
a processing unit comprising:
an audio analyzing module for receiving the audio forwarded by the radio device, and seeking to obtain road keyword and traffic condition keyword associated with the road keyword in the audio after the audio has been converted to a digital signal;
a traffic condition marking module for determining the corresponding road on the navigation map of the detected road keyword and determining designated traffic condition mark of the associated traffic condition keyword of the road keyword, and marking the determined road on the navigation map with the determined traffic condition mark.

2. The navigation device as described in claim 1, wherein the data storage further stores identifiers (IDs) regarding at least one predetermined broadcast stations designated for at least one predetermined area, the navigation device further comprises a positioning unit for positioning the navigation device, the processing unit further comprises a broadcast station determining module for determining the current area of the navigation device and any new area entered by the device according to the position positioned by the positioning unit; obtaining the ID of the predetermined broadcast station of the new area if the new area is one of the predetermined areas, and sending an instruction signal to control the radio device to retune to receive the program of the broadcast station with the obtained ID.

3. The navigation device as described in claim 2, wherein the positioning unit is a global positioning system (GPS) receiver capable of receiving position signals from a GPS satellite.

4. The navigation device as described in claim 1, wherein the traffic condition marks are curved lines with different colors.

5. The navigation device as described in claim 1, wherein the method for detecting road keywords and the traffic condition keywords associated with the detected road keywords is: detecting the road keywords and traffic condition keywords stored in the keyword database in the received audio, if one of the road keywords is detected first, further detecting whether there are traffic keywords within a predetermined portion of audio after the detection of a road keyword; or detecting the road keywords and traffic condition keywords stored in the keyword database in the received audio, and if one of the traffic keyword is detected first, further detecting whether there is one or more road keywords within a predetermined portion of audio after the detection of a traffic keyword.

6. A method for marking traffic conditions on a navigation device storing a navigation map, a keyword database storing a number of keywords, wherein the number of keywords are grouped into road keywords and traffic condition keywords, each road keyword maps one road on the navigation map, each traffic condition keywords corresponds to one traffic condition and is designated a traffic condition mark, comprising:
receiving audio forward by a radio device by an audio receiving unit;
seeking to obtain road keywords and traffic condition keywords associated with the road keywords in the audio after it has been converted to digital signal;
determining the corresponding road on the navigation map of the detected road keyword and determining designated traffic condition mark of the associated traffic condition keyword of the road keyword; and
marking the determined road on the navigation map with the determined traffic condition mark.

7. The method as described in claim 6, further comprising:
storing identifiers (IDs) regarding at least one predetermined broadcast stations designated for at least one predetermined area;
determining the current area of the navigation device and any new area entered by the device according to the position positioned by a positioning unit;
obtaining the ID of the predetermined broadcast station of the new area if the new area is one of the predetermined areas; and
sending an instruction signal to control the radio device to retune to receive the program of the broadcast station with the obtained ID.

8. The method as described in claim 6, wherein the traffic condition marks are curved lines with different colors.

9. The method as described in claim 6, wherein the method for detecting road keywords and the traffic condition keywords associated with the detected road keywords is: detecting the road keywords and traffic condition keywords stored in the keyword database in the received audio, if one of the road keywords is detected first, further detecting whether there are traffic keywords within a predetermined portion of audio after the detection of a road keyword; or detecting the road keywords and traffic condition keywords stored in the keyword database in the received audio, and if one of the traffic keyword is detected first, further detecting whether there is one or more road keywords within a predetermined portion of audio after the detection of a traffic keyword.
